(19) United States
(12) Patent Application Publication
(10) Pub. No.: US 2026/0324559 A1
(43) Pub. Date: Oct. 22, 2026

(54) MODULAR CONCAVE FOR AN AGRICULTURAL COMBINE HARVESTER

(71) Applicant: Bushel Plus Ltd., Brandon (CA)

(72) Inventors: Marcel Kringe, Brandon (CA); Richard Switzer, Brandon (CA)

(21) Appl. No.: 19/693,162

(22) Filed: May 29, 2026

Related U.S. Application Data
(60) Provisional application No. 63/604,139, filed on Nov. 29, 2023.

(30) Foreign Application Priority Data
Nov. 29, 2024 (WO) PCT/CA2024/051600

(51) Int. Cl. A01F 12/26; A01D 41/12; A01F 12/28

(52) U.S. Cl. CPC A01F 12/26; A01D 41/12; A01F 12/28

(57) ABSTRACT

A modular concave assembly for a combine harvester includes a frame having a distal end configured to mount to an inner concave support structure of the combine harvester and a proximal end configured to mount to an outer concave support structure of the combine harvester. The frame includes left and right side plates, a distal end plate, a proximal end plate and a transverse plate disposed between the distal end plate and proximal end plate thereby defining a first frame opening and a second frame opening. A first grate section is sized to be removably received within the first frame opening. A second grate section is sized to be removably received within the second frame opening. At least one of the first and second grate sections configured to mount to the transverse plate each of the first and second grate sections.

### CROSS-REFERENCE TO RELATED APPLICATIONS

This application is a continuation of PCT Application No. PCT/CA2024/051600, filed 29 Nov. 2024, which claims the benefit of US Provisional Application No. 63/604139, filed 29 Nov. 2023, each of which is incorporated herein by reference.

### BACKGROUND

Agricultural combines harvesters include a rotor and concaves which cooperate to thresh the crop material to separate the grain kernels from unwanted crop material. Concaves are comprised of adjacently concave sections which form a partially circular cage partially surrounding the lower third to lower half of the diameter of the rotating rotor along the forward portion of its length. Concaves have different configurations depending on the type of crop being harvested. Thus, the concaves of one configuration are typically swapped out with concaves of another configuration when switching between harvesting of different types of crops.

It can be difficult and time consuming to swap out conventional concave segments. To do so, each concave section must be unbolted from the concave support structure of the combine and the concave section (which can be quite heavy) must be pulled out from around the rotor and removed from the side of the combine before a different concave section can be inserted in place of the previously removed concave section and bolted in place onto the concave support structure of the combine. Thus, it can often take one or two hours or more to swap out all of the conventional concave sections. As a result, growers or operators are often hesitant to swap out concave sections unless they deem it absolutely necessary because they do not want to have any unnecessary downtime, even though the grower or operator may recognize that a different concave configuration may be better suited for a particular type of crop or crop conditions.

Accordingly, there is a need for improved concaves which permit different concave configurations to be swapped out relatively quickly and easily compared to conventional concaves.

### BRIEF DESCRIPTION OF THE DRAWINGS

FIG. 1 is a schematic illustration of conventional combine and showing the flow of crop material through the various threshing, separating and cleaning stages of the combine.

FIG. 2 is a perspective view showing one embodiment of two concave assembly sections oriented as they would be disposed around a pair of parallel axial rotors such as in a Deere X9 combine.

FIG. 3A is an end elevation view showing the two concave assemblies of FIG. 2 and showing the drop-down concave cradle in the raised position.

FIG. 3B is the same view as in FIG. 3A, but showing the concave cradle in the lowered or drop-down position.

FIG. 4 is an upper perspective view of one of the concave assembly sections of FIG. 2.

FIG. 5 is another upper perspective view of the concave assembly section of FIG. 2.

FIG. 6A is a lower perspective view of the concave assembly section of FIG. 2 and showing the drop-down concave cradle in the raised position.

FIG. 6B is another lower perspective view of the concave assembly section of FIG. 2 and showing the concave cradle in the lowered or drop-down position.

FIG. 7 is an exploded upper perspective view of one of the concave assembly sections of FIG. 2, showing the grate insert removed from the frame.

FIG. 8 is an exploded lower perspective view of one of the concave assembly sections of FIG. 2, showing the concave insert removed from the concave frame.

FIG. 9 is an exploded lower perspective view of an embodiment of the grate inserts of FIG. 2.

### DETAILED DESCRIPTION

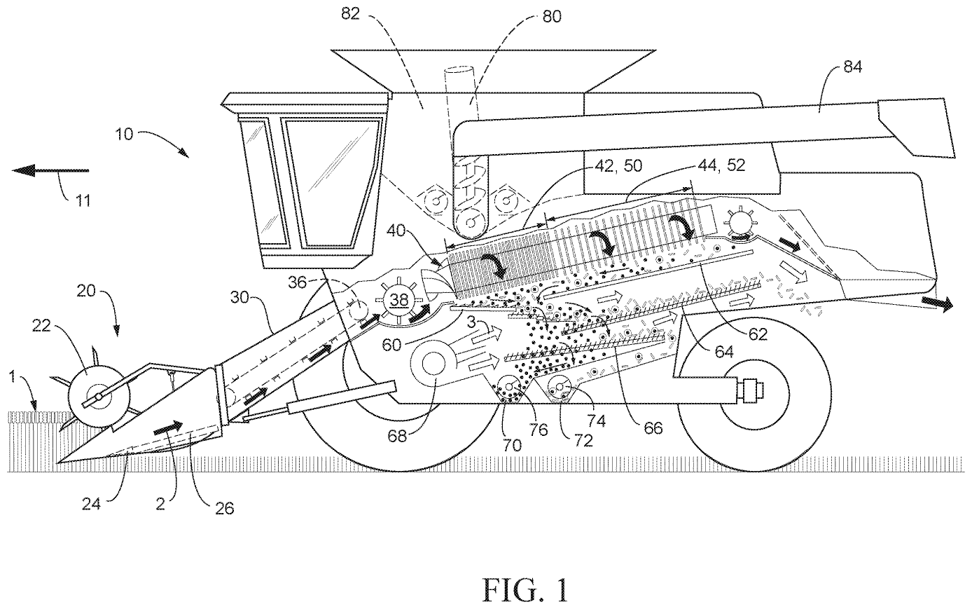

Referring to the drawings, wherein like reference numbers designate the same or corresponding parts throughout the several figures, FIG. 1 is a schematic illustration of conventional combine 10, such as an X9 combine manufactured by Deere & Company, Moline, Illinois, USA (hereinafter referred to as a “Deere X9 combine”). The combine 10, is shown harvesting a standing crop 1, such as wheat. In FIG. 1, the header 20 mounted on the front of the combine, is depicted as a draper header. In operation, as the combine 10 advances through the field in a forward direction of travel designated by arrow 11, the cutter bar 24 cuts the standing crop 1. The rotating reel 22 pulls the cut crop into the header 20. The crop material 2, indicated by solid black arrows, is conveyed by the conveyors 26 toward the middle of the header 20. The header 20 feeds the crop material into the combine's feeder house 30.

It should be appreciated that other types of headers 20 may be mounted on the combine 10. For example, instead of a draper header, the header 20 may be an auger header which includes a similar reel 22 and cutter bar 24 as the draper header, but instead of a conveyer 26 the auger header utilizes a transverse auger to move the crop material 2 toward the middle of the header and into the combine's feeder house 30. Alternatively, instead of a draper header or auger header typically used for harvesting small grains such as wheat, barley, oats, soybeans, canola, etc., the header may be a row crop header, such as corn header. With a corn header, crop dividers or snouts extend between crop rows. Instead of a cutter bar, the corn header utilizes stalk rolls and stripper plates to strip the corn ears from the corn stalks, and instead of a reel to pull the crop into the header, a corn head uses gathering chains to pull the stripped corn ears into a cross-auger which moves the stripped ears toward the middle of the header and into the combine's feeder house. In yet another alternative embodiment, instead of a draper header, auger header or row-crop header, the header may be a pickup header that that picks up a previously cut and windrowed crop. Those of ordinary skill in the art would recognize and understand that, regardless of the type of header, all headers 20 perform the general function of collecting the crop as the combine 10 advances through the field in the forward direction of travel 11 (whether by cutting, stripping or picking up the crop), and feeding the crop material into the combine's feeder house 30.

As illustrated in FIG. 1, the feeder house 30 carries the crop material 2 upwardly and rearwardly toward a rotor 40. The rotor 40 is a cylindrical drum that rotates around its longitudinal axis which may be oriented generally parallel with the direction of travel of the combine (commonly referred to as an “axial rotor” or “axial flow rotor”) or the rotor 40 may be oriented such that its longitudinal axis is transverse to the direction of travel of the combine (commonly referred to as a “transverse rotor” or “transverse flow rotor”). In some combines, such as the Deere X9 combine for example, a pair of parallel axial rotors are utilized instead of one axial rotor. A feed accelerator 38 may be disposed between the feeder house 30 and the rotor 40 to assist in feeding the crop material 2 into the rotor 40.

The rotor 40 is partially surrounded by concaves 42 which form a cage structure partially surrounding approximately the lower half or more of the circumference of the rotor 40 along the forward portion of its length, defining the threshing zone 50 of the rotor 40. Separating grates 44 are disposed along the rearward portion of the rotor defining the separating zone 52 of the rotor 40. The concaves 42 are spaced radially outward from the outwardly projecting rasp bars (not shown), also referred to as flighting, fingers or beaters, extending radially outward from the surface of the rotor 40. The concaves 42 may be radially adjustable to vary the radially outward spacing of the concaves 42 with respect to the rotor 40. As schematically represented in FIG. 1, the concaves 42 are typically comprised of spaced bars or wires resulting in slots between the bars or wires. The size, shape and spacing of the bars or wires vary depending on the type of crop being harvested. Thus, growers or operators will typically have several sets of interchangeable concaves with different configurations. Additionally, different concave configurations are often used in combination along the threshing zone 50 of the rotor 40. For example, the forwardmost concaves 42 may have wider bars or wires that are more closely spaced, resulting in narrower width slots, whereas the rearward concaves 42 may have narrower bars or wires with wider spacings, resulting in wider slots.

In operation, as the rotor 40 rotates about its longitudinal axis, the crop material 2 is raked over and along the concaves 42 within the threshing zone 50 to dislodge the grain kernels from the unwanted crop material. The threshed crop passes from the threshing zone 50 to the separating zone 52 where the crop material 2 is raked over the separating grates 44. As shown in FIG. 1, the separated grain kernels (represent by black dots) and some unwanted crop material comprising tailings (represented by circled black dots) and chaff (represented by small rectangles) will fall by gravity through the slots between the bars or wires of the concaves 42 and separating grates 44. Ideally, all of the grain kernels are dislodged and separated from the unwanted crop material, (e.g., straw, leaves, stalks, stems, husks, cobs, etc., depending on the crop being harvested), hereinafter referred to as “residue”, before the residue passes out of the rotor 40 and is discharged out the rear for the combine 10. The separated grain kernels, tailings and chaff passing through the slots of the concaves 42 and separating grates 44 fall by gravity onto a forward pan 60 and a rearward pan 62 disposed below the rotor 40. The forward and rearward pans 60, 62 direct the clean grain, chaff and tailings that passed through the slots of the concaves 42 and separating grates 44 toward upper and lower sieves 64, 66. A blower 68 disposed forward of the sieves 62, 64 produces a rearwardly directed air stream indicated by unfilled arrows 3. The air stream 3 carries most of the lighter chaff out the rear of the combine. Ideally, all of the separated grain kernels pass through the sieves 64, 66 and are directed to a clean grain trough 70. Any tailings, comprising larger pieces of unwanted crop material that did not pass through the sieves, and which may still contain unseparated grain kernels are directed into a tailings trough 72. A tailings auger 74 moves the tailings to a tailing elevator (not shown) which returns the tailings to the separating zone 52 of the rotor for separating any remaining grain kernels from the unwanted crop material. The clean grain kernels collected within the clean grain trough 70 are moved by a clean grain auger 76 to a clean grain elevator (not shown). The clean grain elevator lifts the clean grain kernels upwardly toward a grain tank auger 80. The grain tank auger 80 augers the clean grain kernels into the grain tank 82 which holds the clean grain until it is offloaded to a grain cart or other transport vehicle (not shown) via an outwardly swinging unload auger 84.

As described under the Background section above, when switching from harvesting one type of crop to another type of crop or under other conditions, it may be necessary to change or swap out the concaves 42 from one configuration to another configuration. The concaves 42 are typically comprised of concave sections, each defining an arc length that surrounds approximately the lower third to lower half of the circumference of the rotor 40. To replace or swap out conventional concaves 42, each concave section must be unbolted from the concave support structure of the combine 10 and the concave section (which can be quite heavy) must be pulled out from under the rotor 40 and removed from the side of combine before a different concave section can be inserted in place of the previously removed concave section and then the newly installed concave section is bolted in place onto the concave support structure of the combine. It can often take one or two hours or more to swap out all of the conventional concave sections. As a result, growers or operators are often hesitant to swap out the concaves unless it is absolutely necessary, because they do not want to minimized downtime, even at the risk of higher crop losses or the risk of more unwanted crop material in the grain tank due to improper improper threshing and separating of the grain kernels which could be minimized by using a different concave configuration.

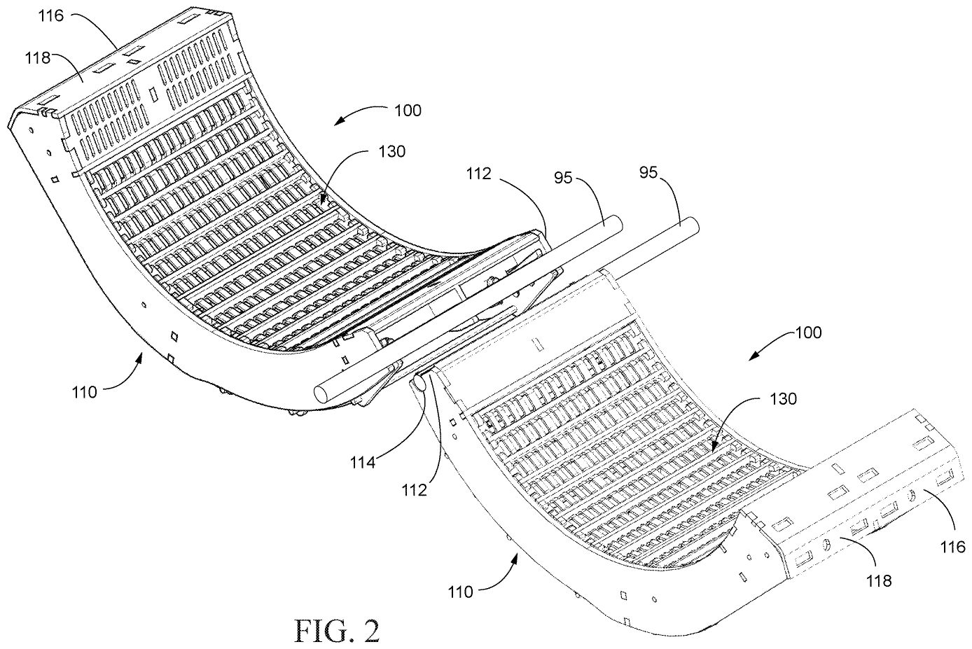

To overcome the above disadvantages, a modular concave assembly 100 is hereinafter described and illustrated in FIGS. 2-10. Referring first to FIG. 2, two modular concave assembly sections 100, are shown in perspective view representing how the two modular concave assembly sections 100 would be installed and oriented for a combine harvester having a pair of parallel axial rotors, such as in a Deere X9 combine. In the embodiment shown in FIG. 2, each of the concave assembly sections 100 are identical to one another, but are oriented as mirror images of one another. While the modular concave assembly 100 is particularly adapted for parallel axial rotors such as the Deere X9 combine, it should be appreciated that the modular concave assembly 100 may adapted for use with any combine harvester, including combine harvesters with parallel axial rotors, or a single axial rotor or a transverse rotor.

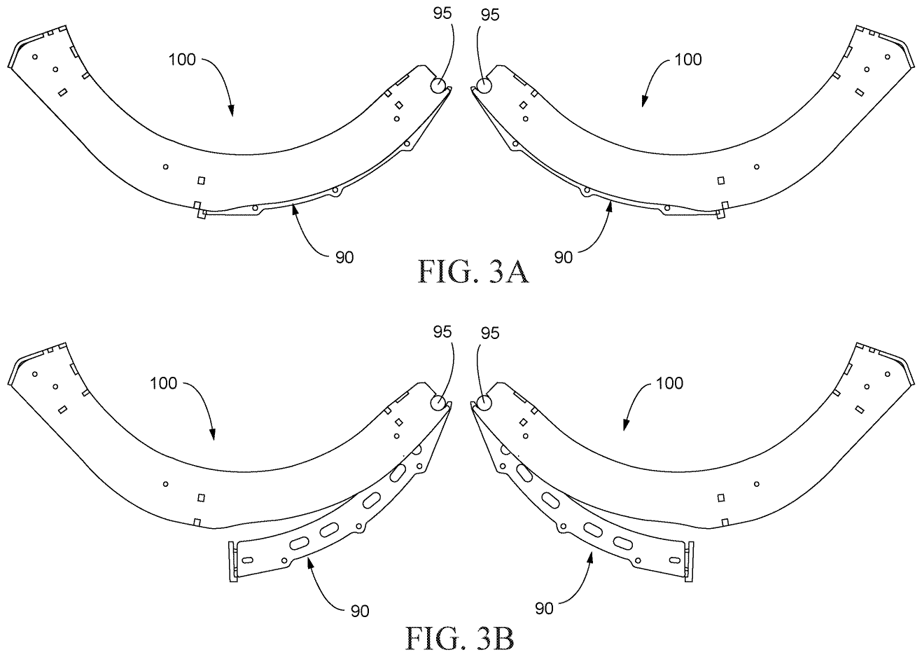

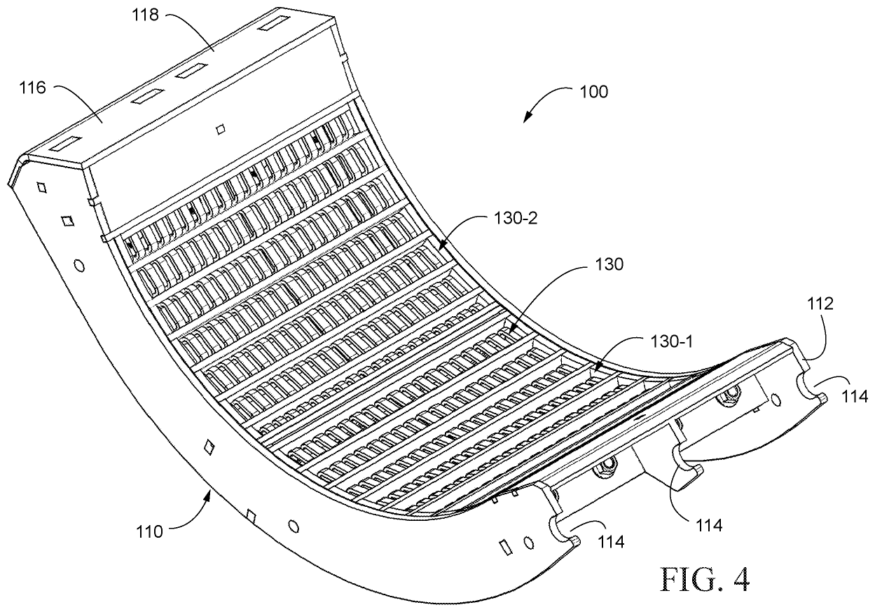

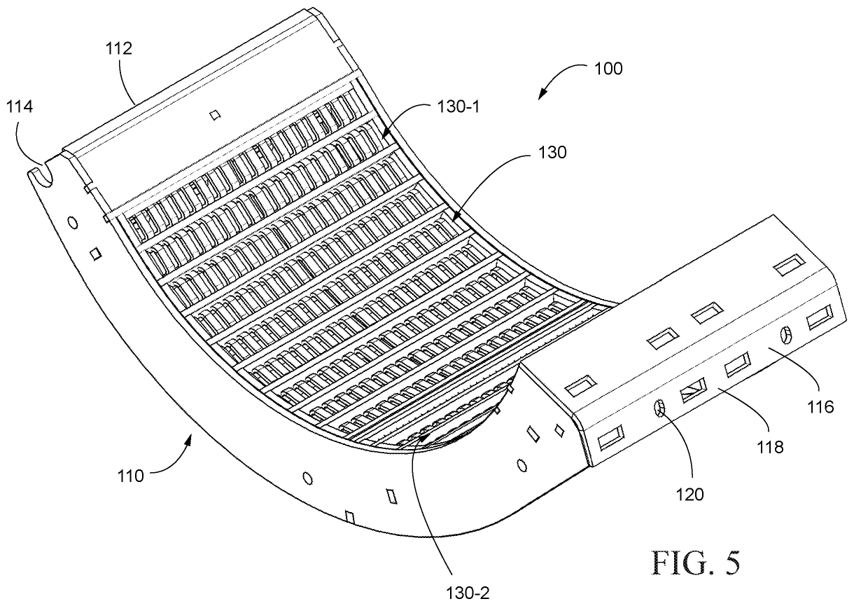

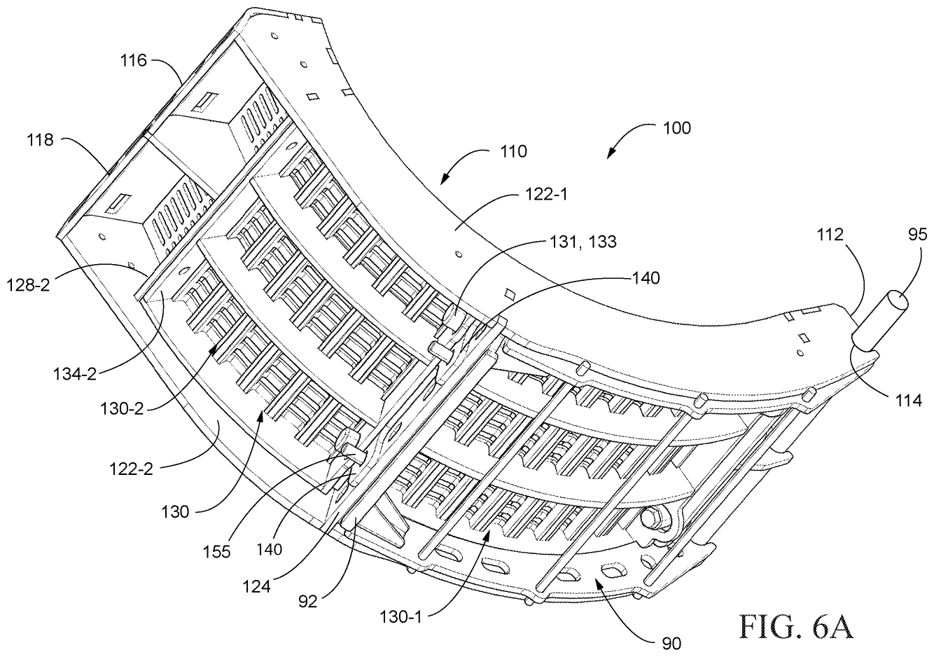

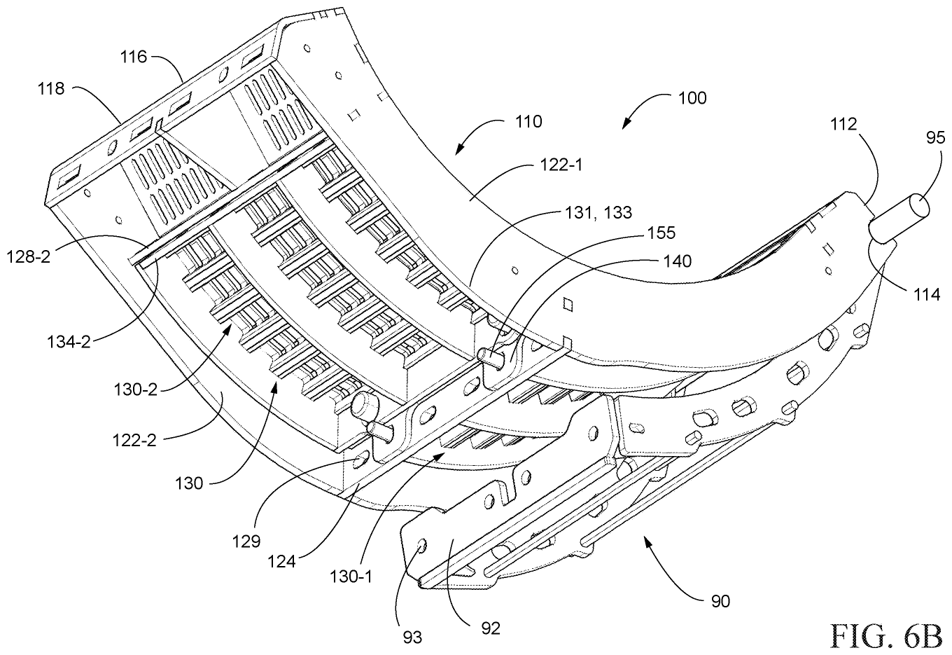

As discussed above, in use, adjacent modular concave assembly sections 100 would be disposed side-by-side along the entire length of the threshing zone 50 of the rotor 40. FIGS. 3A and 3B are end views of the concave assembly sections of FIG. 2. FIG. 3A shows the drop-down concave cradle (discussed later) in the raised position and FIG. 3B shows the concave cradle in the lowered or drop-down position. FIG. 4 is an upper perspective view of one of the modular concave assembly sections 100 shown in FIG. 2. FIG. 5 is another upper perspective view of one of the modular concave assembly sections 100 shown in FIG. 2. FIGS. 6A and 6B are lower perspective views of the modular concave assembly segment 100 shown in FIG. 2. FIG. 6A shows the drop-down concave cradle (discussed later) in the raised position and FIG. 6B shows the concave cradle in the lowered or drop-down position.

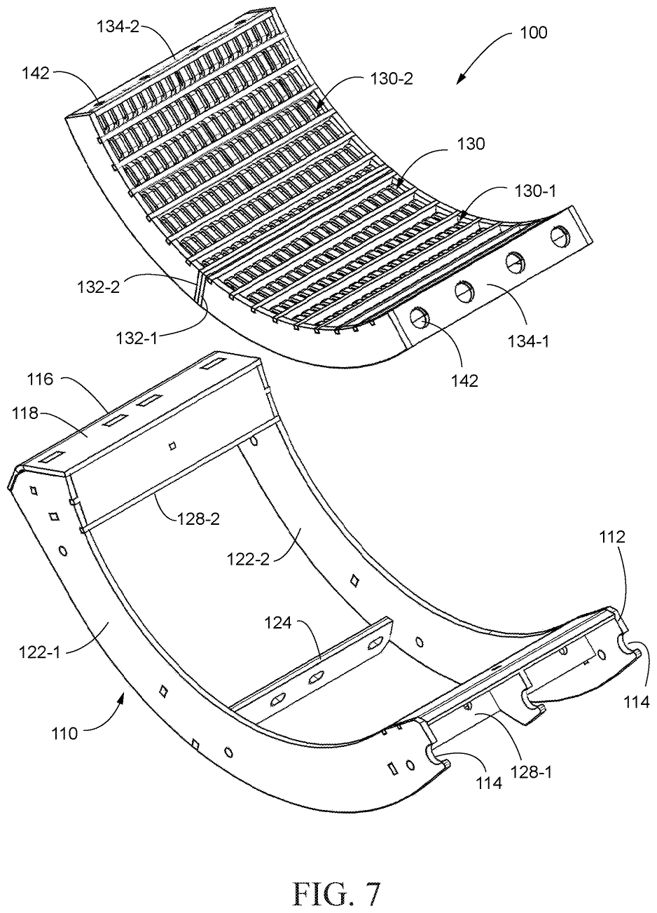

To overcome the disadvantages of conventional concave sections described above, the concave assembly sections 100 are modular and are comprised of a universal frame 110 that removably receives interchangeable grate inserts 130 as best illustrated in the exploded views of FIGS. 7-9. As discussed in more detail later, each universal frame 110 is configured to mount to the combine harvester 10 in the same manner as the original equipment manufacturer (OEM) concave sections 42 that they are intended to replace.

A particular advantage to the modular construction of the concave assembly sections 100 is that once the universal frame 110 is mounted into place on the concave support structure of the combine 10, the grate inserts 130 may be separately removed from the universal frame 110 and replaced with other grate inserts 130 of a different configuration particularly suitable for the type of crop or crop conditions without having to remove the universal frame 110 from under the rotor 40. Thus, this modular configuration allows the grower or operator to swap out the grate inserts 130 within minutes as opposed to hours for swapping out the conventional OEM concave sections 42. Furthermore, since the different configurations of the grate inserts 130 are independent of the universal frame 110 it allows the grower or operator to have more concave configuration options available for different types of crops and crop conditions at a lower cost than what the grower or operator may otherwise have with conventional concaves, since only the different grate inserts 130 need to be purchased, each of which is interchangeable and adapted for mounting to the same universal frame 110.

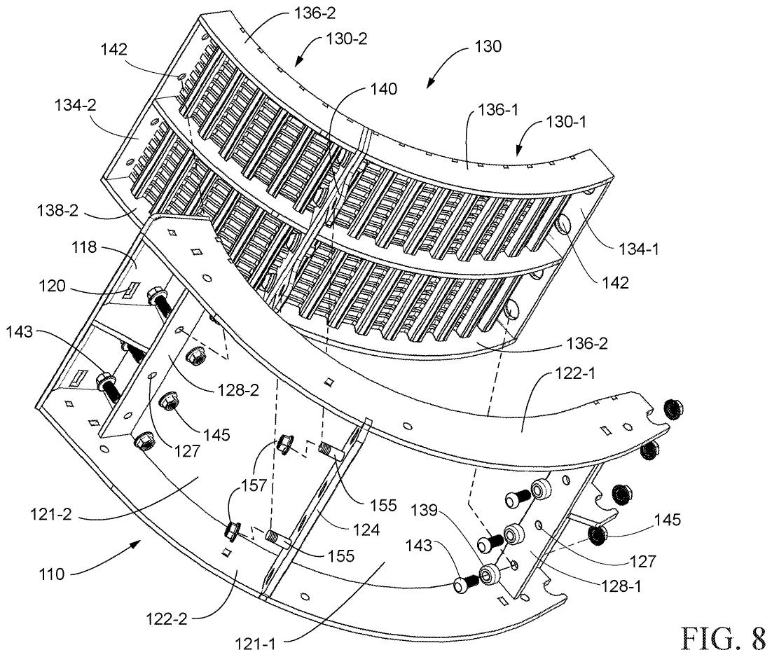

As best viewed in FIGS. 2 and 8, the frame 110 includes a distal end 112 and a proximal end 116, a right side plate 122-1 and a left side plate 122-2. A distal end plate 128-1 and a proximal end plate 128-2 each extends transversely between the side plates 122-1, 122-2. A transverse plate 124 extends transversely between the side plates 122-1, 122-2 between the distal end plate 128-1 and the proximal end plate 128-2, thereby defining a first frame opening 121-1 and a second frame opening 121-2. The first frame opening 121-1 receives a first grate insert section 130-1. The second frame opening 121-2 receives a second grate insert section 130-2. The first and second grate insert sections may be collectively referred to as the grate insert 130.

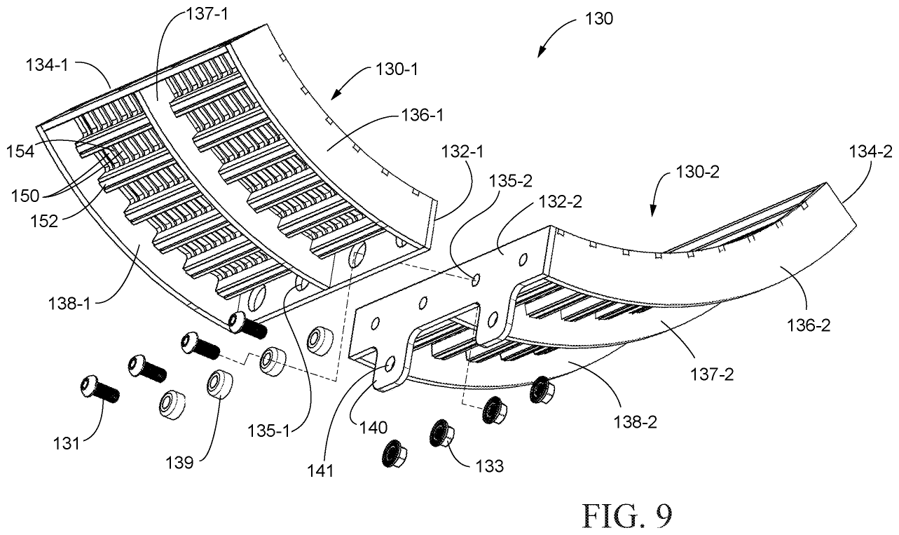

Each grate insert section 130-1, 130-2 may include respective inner end plates 132-1, 132-2 and respective outer end plates 134-1, 134-2 and side plates 136-1, 138-1; 136-2, 138-2. Each grate insert section may also include one or more an intermediate plates 137-1, 137-2. The inner end plates 132-1, 132-2 may be joined end-to-end by threaded bolts or screws 131 receivable through aligned apertures 135-1, 135-2 in the respective inner end plates 132-1, 132-2 and secured together by nuts 133. As illustrated in FIG. 9, the apertures in one of the inner ends of the grate sections may be enlarged for easier alignment of the apertures 135-1, 135-2 in inner end plates 132-1, 132-2. The enlarged aperture may receive an elastomeric or steel insert 139 to center the bolts or screws 131 within the enlarge apertures. One of the inner end plates 132-1, 132-2 includes mounting ears 140 with an aperture 141 for securing the joined grate sections 130-1, 130-2 to the transverse plate 124. As best illustrated in FIGS. 7 and 8, the outer end plates 134-1, 134-2 include apertures 142 which align with mating apertures 127 in the distal and proximal end plates 128-1, 129-2 of the frame 110 through which bolts or screws 143 are inserted and secured with nuts 145. The apertures 142 in one of the outer ends of the grate insert sections 130-1, 130-2 may be enlarged for easier alignment with the apertures 127 in the distal and proximal end plates plates 128-1, 128-2. The enlarged apertures 142 may receive an elastomeric or steel insert 139 (FIG. 8) to center the bolts or screws 143 and nuts 145 within the enlarged apertures 142.

In the embodiment of the grate insert 130 shown in FIGS. 2-9, and as best illustrated in FIG. 9, each grate insert section 130-1, 130-2 includes a series of spaced bars 150 and rails 152 supported by the respective side plates 136-1, 138-1, 136-2, 138-2 and one or more intermediate plates 137-1, 137-2. The spaced bars 150 define slots 154 through which the grain kernels will pass as the crop material is raked over the bars 150 and rails 152 by the rotor 40 as described above. It should be understood that the configuration of the grate insert 130 shown in FIGS. 2-9 is illustrative only since an object of the concave assembly segment 100 is to provide a universal frame 110 to which different configurations of grate inserts 130 are removably attached. For example, instead of the grate insert 130 being constructed and configured as shown in FIGS. 2-9 with generally flat bars 150 and rectangular shaped transverse rails 152, with a relatively narrow spacing defining narrow slots 154 between the flat bars 150, in an alternative configuration the flat bars 150 could be narrower resulting in wider slots 154. Alternatively, the flat bars 150 could have larger spacings resulting in wider slots 154. Alternatively, instead of flat bars 150 and rectangular transverse rails 152, the bars 150 and rails 152 could be made of round bar stock or other bars stock shapes of different diameters or cross-sections with different spacings, producing various width slots 154. Alternatively, the number of rails 152 could be reduced or eliminated resulting in longer slots 154. Alternatively, the grate inserts 130 could be made of different diameter wires woven together to form a mesh-like configuration. Alternatively, the grate inserts 130 could be made of steel plate with an arcuate configuration to match the arcuate shape of the frame 110 with the steel plate having different cutout configurations forming slots 154 of different shapes (e.g., round, obround, rectangular, etc.) with various spacings and orientations. In other words, it should be appreciated that the grate insert 130 received within the frame 110 may have any desired construction over which the crop material is raked and any desired slot configuration through which the separated grain kernels will pass.

It should be understood that the frame 110 may be configured to match the concave mounting structure of a particular make and model of combine harvester. Thus, the configuration of the frame 110 may vary from that shown in FIGS. 2-8, which is shown as being particularly configured for mounting to a Deere X9 combine. For example, the distal end 112 of the frame 110 is shown has having hooks or circular cutouts 114 sized to matingly receiving the concave mounting rail 95 (FIG. 2) of the Deere X9 combine. Other OEM makes and models of combines may have a different concave mounting rail or structure such that the distal end 112 of the frame 110 would be configured to receive or be supported by the concave mounting rail or structure of the particular OEM combine make and model. Likewise the proximal end 116 of each frame 110 includes a frame end plate 118 with apertures 120 for aligning with the apertures in the OEM concave mounting structure of the combine 10 (referred to as the “Z-bar” in Deere combines), for receiving mounting bolts (not shown). Again, other OEM makes and models of combines may have a different mounting structure so the proximal end 116 would be configured to mount to the particular concave mounting structure of the particular OEM combine make and model. As best viewed in FIGS. 7-8, in the embodiment shown, the distal ends of the right and left side plates members 122-1, 122-2 include the hooks or cutouts 114.

The transverse plate 124 is positioned along the length of the frame 110 to accommodate the OEM drop-down concave cradle 90 (also commonly referred to as a concave ladder) provided on many combines, including Deere X9 combines. An example of a drop-down concave cradle 90, such as on Deere X9 combines are shown in FIGS. 3A-3B and 6A-6B. Those of ordinary skill in the art would recognize and understand the purpose of drop-down cradles 90. In summary, when the cradle 90 is in the lowered or drop-down position as shown in FIGS. 3B and 6B, it serves to support the weight of the heavy concave section which allows the concave section to be more easily slid into place during installation. Similarly, during removal of the concave section, the cradle 90 bears the weight while the concave section as it is being slid out from under the rotor 40 until it can be lifted away. When the concave section is secured in place in the operating position, i.e., supported on the rail 95 at the distal end 112 and bolted onto the Z-bar or other mounting structure at the proximal end 116, the cradle 90 is raised and bolted to the concave section. Thus, it should be appreciated, that the frame 110 and grate inserts 130 of the modular concave assembly section 100 is designed to accommodate the OEM cradle 90. The transverse plate 124 is therefore positioned along the frame 110 at the proper location so that when the cradle 90 is lifted or raised into the operating position, the end plate 92 (FIG. 6B) of the cradle 90 is able to be secured to the frame 110 by a bolted connection or threaded fastener through aligned apertures 129, 93 (FIG. 6B) in the respective transverse plate 124 and the end plate 92 of the cradle 90.

The transverse plate 124 may include threaded studs 155 that align with the apertures 141 in the ears 140 of the grate inserts 130-1, 130-2 to secure the grate inserts 130-1, 130-2 to the frame 110 with a nut 157. Rather than a threaded stud 155, the transverse plate 124 may include apertures for a bolted connection. The distal and proximal end plates 128-1, 128-2 include apertures 127 that align with apertures 142 in the end plates 134-1, 134-2 of the grate inserts 130-1, 130-2, through which the bolts or screws 143 are received and secured by nuts 145 to further secure the grate inserts 130-1, 130-2 to the frame 110.

The grate insert 130 may be removed from the frame 110 as a unit or the individual grate sections 130-1, 130-2 may be individually removed from the frame 110 by simply removing the nuts and bolts, 143, 145, 157 while the proximal end 116 of the frame 110 is in the drop-down position on the lowered cradle 90 while the distal end 112 remains supported on the rail 95. Different grate insert sections 130-1, 130-2 can then be installed onto the lowered frame 110 quickly and easily. Once the desired grate sections 130-1, 130-2 are installed, the proximal end 116 of the modular concave assembly 100 is then raised to the operating position and bolted in place to the combine's Z-bar or other concave mounting structure. The cradle 90 is then raised and bolted to the transverse plate 124 of the frame 100.

The foregoing description and drawings are intended to be illustrative and not restrictive. Various modifications to the embodiments and to the general principles and features of the concave segments 100 described herein will be apparent to those of skill in the art. Thus, the disclosure should be accorded the widest scope consistent with the appended claims and the full scope of the equivalents to which such claims are entitled.

1. A modular concave assembly for a combine harvester, comprising:
a frame having a distal end configured to mount to an inner concave support structure of the combine harvester and a proximal end configured to mount to an outer concave support structure of the combine harvester, the frame including left and right side plates, a distal end plate, a proximal end plate and a transverse plate disposed between the distal end plate and proximal end plate thereby defining a first frame opening and a second frame opening;
a first grate section sized to be removably received within the first frame opening;
a second grate section sized to be removably received within the second frame opening;
at least one of the first and second grate sections configured to mount to the transverse plate each of the first and second grate sections.

2. The modular concave assembly of claim 1, wherein the transverse plate is disposed along the right and left side plates to align with and attach to a concave cradle disposed on the combine harvester.

3. The modular concave assembly of claims 1, wherein the first and second grate insert sections comprise spaced bars and rails defining slots.

4. The modular concave assembly of claims 2, wherein the first and second grate insert sections comprise spaced bars and rails defining slots.

5. The modular concave assembly of claims 1, wherein the first and second grate insert sections comprise wires defining slots.

6. The modular concave assembly of claims 2, wherein the first and second grate insert sections comprise wires defining slots.

7. The modular concave assembly of claims 1, wherein the first and second grate insert sections comprise stamped plates defining slots.

8. The modular concave assembly of claims 2, wherein the first and second grate insert sections comprise wires defining slots.

9. A concave apparatus for use in a combine harvester where the combine harvester includes:
first and second side by side threshing and separating rotors;
each rotor having associated therewith mounting arrangements for mounting a series of arcuate side by side concave elements, where each concave element extends angularly around a portion of the cylinder and where the side by side concave element are arranged at positions along the axis of the rotor;
the mounting arrangement including an upper support for receiving an upper end of a respective concave element and a lower support for receiving a lower end of the respective concave element;
the concave apparatus comprising:
a concave support frame including two side rails arranged to lie in respective radial planes of the axis and extend around the portion of the cylinder and a plurality of transverse connecting bars at right angles to the side rails;
a pair of concave inserts each for insertion into and mounting on the concave support frame;
each concave insert having a rectangular arcuate body with a plurality of rub bars facing the rotor for cooperation therewith;
the transverse connecting bars of the concave support frame including an upper bar, a center bar and a lower bar defining an upper rectangular space for an upper one of the pair of concave inserts and a lower rectangular space for a lower one of the pair of concave inserts;
the upper concave insert having a lower transverse bar at a lower end and an upper transverse bar at an upper end;
wherein the upper transverse bar of the upper concave insert removably attaches to the upper transverse bar of the concave support frame;
wherein the lower transverse bar of the upper concave insert removably attaches to the center transverse bar of the concave support frame;
the lower concave insert having a lower transverse bar at a lower end and an upper transverse bar at an upper end;
wherein the upper transverse bar of the lower concave insert removably attaches to the center transverse bar of the concave support frame;
wherein the lower transverse bar of the lower concave insert removably attaches to the lower transverse bar of the concave support frame.

10. The concave apparatus according to claim 9, wherein upper and lower concave inserts are symmetrical for use in either the upper space or the lower space.

11. The concave apparatus according to claim 9, wherein each of the concave inserts includes side rails, each of which lies immediately adjacent a respective side rail of the concave support rail.

12. The concave apparatus according to claim 11, wherein the side rails of the concave insert are narrower than the concave support rails.

13. The concave apparatus according to claim 11, wherein the transverse connecting bars of the concave support frame have a depth substantially equal to the side rails of the concave insert.

14. The concave apparatus according to claim 9, wherein the transverse connecting bars of the concave support frame include a top bar above the upper bar for attachment to the upper support of the mounting arrangement.

15. The concave apparatus according to claim 14, wherein the lower support of the mounting arrangement comprises a cylindrical rod extending parallel to the axis and the lower engagement portion comprises on each side rail a respective cup shaped receptacle for receiving the rod.

16. The concave apparatus according to claim 9, wherein the upper support of the mounting arrangement extends parallel to the axis and wherein the top bar of the concave support frame mateably engages with the upper support of the mounting arrangement.

17. A combine harvester comprising:
first and second side by side threshing and separating cylindrical rotors each rotatable about a respective axis of the rotor;
a concave apparatus comprising a series of arcuate side by side concave elements, each rotor having associated therewith mounting arrangements for mounting the side by side concave elements;
where each concave element extends angularly around a portion of the cylindrical rotor;
where the side by side concave elements are arranged at positions along the axis of the rotor;
the mounting arrangement including an upper support for receiving an upper end of a respective one of the concave elements and a lower support for receiving a lower end of a respective one of the concave elements;
each of the respective ones of the concave elements comprising:
a concave support frame including two side rails arranged to lie in respective radial planes of the axis and extend around the portion of the cylinder and a plurality of transverse connecting bars at right angles to the side rails;
a pair of concave inserts each for insertion into and mounting on the concave support frame;
each concave insert having a rectangular arcuate body with a plurality of rub bars facing the rotor for cooperation therewith;
the transverse connecting bars of the concave support frame including an upper bar, a center bar and a lower bar defining an upper rectangular space for an upper one of the pair of concave inserts and a lower rectangular space for a lower one of the pair of concave inserts;
the upper concave insert having a lower transverse bar at a lower end and an upper transverse bar at an upper end;
wherein the upper transverse bar of the upper concave insert removably attaches to the upper transverse bar of the concave support frame;
wherein the lower transverse bar of the upper concave insert removably attaches to the center transverse bar of the concave support frame;
the lower concave insert having a lower transverse bar at a lower end and an upper transverse bar at an upper end;
wherein the upper transverse bar of the lower concave insert removably attaches to center transverse bar of the concave support frame;
wherein the lower transverse bar of the lower concave insert removably attaches to the lower transverse bar of the concave support frame.

18. The combine harvester according to claim 17, wherein upper and lower concave inserts are symmetrical for use in either the upper space or the lower space.

19. The combine harvester according to claim 17, wherein each of the concave inserts includes side rails each of which lies immediately adjacent a respective side rail of the concave support rail; wherein the transverse connecting bars of the concave support frame have a depth substantially equal to the side rails of the concave insert.

20. The combine harvester according to claim 17, wherein the transverse connecting bars of the concave support frame include a top bar above the upper bar for attachment to the upper support of the mounting arrangement.
